(19) United States
(12) Patent Application Publication
(10) Pub. No.: US 2007/0034808 A1
(43) Pub. Date: Feb. 15, 2007

(54) METHOD AND SYSTEM FOR DETECTION AND IDENTIFICATION OF RAPIDLY MOVING RADIOACTIVE SOURCES

(75) Inventor: Rollin Evans, Albuquerque, NM (US)

Correspondence Address: TED SABETY, ONE PENN PLAZA, 36TH FL., NEW YORK, NY, 10119, US

(73) Assignee: Applied Research Associates, Inc., Albuquerque, NM (US)

(21) Appl. No.: 11/380,576

(22) Filed: Apr. 27, 2006

Related U.S. Application Data
(60) Provisional application No. 60/692,361, filed on Jun. 21, 2005.
(60) Provisional application No. 60/675,331, filed on Apr. 27, 2005.

(51) Int. Cl. G01T 1/26

(52) U.S. Cl. 250/371

(57) ABSTRACT

A system to detect low-level nuclear devices concealed in vehicles on public roadways. Non-Poissonian background fluctuations occur in a single radiation detector, in a period of time small compared to the passage of a radioactive source in front of a detector. The background fluctuations do not correlate from detector to detector or time slice to time slice. A source passing in front of the detector causes fluctuations in both detectors; and the fluctuations continue during the time period the source is near the detector. Statistical analytic processes are used to discern the differences between background fluctuations and source induced fluctuations in order to obtain a high-sensitivity, low false alarm hit detection system

### PRIORITY

This application claims priority to U.S. patent Ser. No. 60/692,361, filed Jun. 21, 2005 and U.S. patent application Ser. No. 60/675,331 filed on Apr. 27, 2005 and U.S. patent application Ser. No. 10/765,116 filed Jan. 28, 2004.

### ACKNOWLEDGEMENT

Part of this work was supported (in part) by the Defense Threat Reduction Agency, Combat Support Nuclear Programs Division (DTRA/CSNP) under the Unconventional Nuclear Weapon Defense (UNWD) Program, Contract No. ______.

### BACKGROUND AND SUMMARY OF THE INVENTION

The sensitivity of detection systems to passage of radioactive sources can be increased through larger detectors, higher resolution of the detectors, or suppression of background counts. An additional method to detect the passage of a fast moving radioactive source is by using the difference in count statistics between background alone and background and the moving source. This method allows the detection of very low count sources, with a very low level of false alarms due to background fluctuations. This method is enhanced through the use of multi-channel analyzers capable of timing pulse arrivals to within 1 μs. The use of various correlation techniques allows the detection of source strengths of tens of μCi moving at highway speeds. Portions of the system described herein are based on embodiments described by R. Evans, G. Berzins, C. Moss and R. Jones, “Detection and Identification of Radiation Sources Traveling at Highway Speeds”, Paper 181, Proceedings of the INMM 44th Annual Meeting (2003), which is incorporated herein by reference.

### SUMMARY OF THE INVENTION

A detection system that can alert a facility to the presence of a vehicle-transported nuclear weapon or radiological dispersal device (RDD) is desired. The basic system is a detector or detectors, channel electronics and a computer system on a data network. The detectors are serviced by the channel electronics, which deliver radiation count and energy data to the computer, which is comprised of input/output electronics, a central processor and mass storage, all operatively coupled and under the control of an operating system. The computer executes software code embodying methods described herein, the code be delivered on a disk or as a download or stored on the mass storage device. The computer analyzes the data in accordance with the methods described herein. If the result of the analysis is a determination that a nuclear device is present, any number of alarms can be created, alarms including visual indication on a control screen, audible alarms, closing of gates, raising of fences, transmittal of a message across the Internet to a destination, actuation of a still or video camera, actuation of a audio recording device, activation of countermeasures, blinking lights and the triggering of any other kind of security response. All of these are alarms for the purpose of this disclosure. For the system to provide effective protection, the weapon must be interdicted at a significant distance from the facility. Reasonable assumptions about response time indicate that first detection must be made at approximately 25 miles from the site being protected. For the system to be effective, radiation detection on public highways is required. To avoid disruption of normal vehicle traffic, source detection must be accomplished at full vehicle speeds of ˜60-70 mi/hr at stand-off distances of 2-5 meters.

A non-negligible amount of roadway traffic transports legitimate radioactive sources. Given the required urgency of the response to weapon detection, responders cannot be deployed every time a radiation source is detected. Identification (ID) of the isotope(s) causing the detection must be made, or the system is impractical. The system requires high sensitivity, in part because an actual threat may be shielded. The interaction time between source and detector is ˜200-300 ms, so the detector counting time must be less than 200-300 ms. High system sensitivity, coupled with the required high reporting rate, must not lead to a high rate of false alarms due to background fluctuation. The system must operate automatically, and have low maintenance requirements. Given the large number of possible sensor sites required to instrument the detection zone, equipment cost is also a consideration.

There are three main steps in a pass-by monitor-detecting the passage of the source, the identification of that source, and the decisions based on the information from the monitor. The first part of that process is determining with some probability that a source has passed the detector. This paper discusses methods being used to give high sensitivity source detection with low occurrence of background induced false alarms.

In a pass-by situation a detection of a radioactive source moving at highway speeds (typically 30-70 mph) at distances typical of a highway lane (˜2-3 m) is attempted. This situation is characterized by source-detector interaction times of less than one second. Data acquisition is typically divided into time bins of duration shorter than the expected source-detector interaction time. Then only the counts occurring during source passage can be combined, providing optimum signal to noise for the source identification. The hit detection method determines if a source was present, and the period of time which the source was in the detector field of view.

Sensitive detection and identification of rapidly moving radioactive sources has been demonstrated as part of a prototype system developed for real-time detection and notification of unauthorized radioactive material movement. A radiation detection system employing large-volume radiation sensors for pass-by detection of radioactive sources has been designed, assembled, tested, and modeled. The custom system uses a variety of commercially available detector and electronic components and special analysis software. Tests have been conducted using sources placed in vehicles traveling along highways over a range of speeds and separations between detector and source. The system reliably detected and identified in real time sources that were part of the testing procedure, in addition to numerous other industrial and medical sources.

### PRIOR ART

The patent disclosure US 2005/0023477 by Archer, et. al., (incorporated herein by reference) describes the basic architecture of a system to detect radioactive sources in moving vehicles. There is a detector which drives a multi-channel analyzer and a computer hosting the analyzer. The computer processes the data from the analyzer in order to determine whether a source has been detected. However, Archer's disclosure relies on peak detection using “Sequential Probability Test Ratio.” This approach does not provide sufficient sensitivity while limiting the false positive rate. P. E. Fehlau, “An Applications Guide to Vehicle SNM Monitors”, Los Alamos National Laboratory Report LA-10912-MS, March 1987 discloses simple count level detection, which is inferior because it does not sufficiently discriminate background radiation from sources, thus resulting in a poor trade-off between sensitivity and false positive detections. That system used a plastic scintillation detector, level detection electronics and a basic computer system for controlling alarms, gates, cameras and other typical peripheral devices in the security field. The product by Canberra, called Rad-Sentry has been on the market about 10 years, which also uses a plastic scintillation detector, controlling computer, graphical displays and communication of alarm events. None of these systems are sufficiently accurate whereby there is a very low false-positive rate while the sensitivity is maintained to detect small nuclear threats that may be shielded to avoid detection.

### BRIEF DESCRIPTION OF THE DRAWINGS

FIG. 1. Distinguishing background from source counts.

FIG. 2. Comparison of predicted count statistics to measured count statistics for 1 and 2 detectors. (Measurement conditions: time bin 65.536 ms, two 3×3 detectors operating side-by-side, gain stabilized, 256 channels.)

FIG. 3. Detection count rates with one and two detectors

FIG. 4. Example of total counts vs. counting bin

FIG. 5. Spectra obtained from FIG. 4 hit detection

FIG. 6. Multi-channel analyzer timing diagram

FIG. 7. Expected number of background counts in 0.125-sec. time slice (rᵢτ)

FIG. 8. Counts required to exceed probability levels in a single detector, single time slice

FIG. 9. Neutron detector assembly with front HDPE panel removed

FIG. 10. Total counts for 137Cs source pass-by at 15 m/s. Note: riτ is the average background for channel i

FIG. 11. Comparison of counts in a channel to probability of counts occurring due to background

FIG. 12. Single detector threshold comparison for N_{b}=20, P_{Fa}=10⁻⁸, Cₙ=256, N_{d}=2

FIG. 13. Individual time bin probability of success vs. overall probability of detection (0.1≦P_{d}≦1.0)

FIG. 14. Individual time bin probability of success vs. overall probability of detection (0.80≦P_{d}≦1.0)

FIG. 15. Required scattering rates for the “or” vs. the “and” detection schemes

### DETAILED DESCRIPTION OF THE PREFERRED EMBODIMENTS

Source detection involves determining with some probability that a source has passed the detector(s). This normally involves detecting an increase in the count rate as compared to total background. This standard method suffers when the increase in counts from a source is small compared to the normal background fluctuation. Simply using fluctuations in total counts to indicate source passage leaves the user with the option of having an insensitive system, or constantly responding to background induced false alarms (referred to herein as BIFA). Increasing the system sensitivity while reducing BIFA requires an understanding of differences between background fluctuations and source count induced fluctuations.

The probability of a number of counts n being detected, from Poisson statistics is given as

$$P ( n ) = \frac{{μ}^{n} {ⅇ}^{- μ}}{n !} ,$$

where μ is the mean number of counts detected. The standard deviation of the Poisson deviation is the square root of the mean. Source passage is normally detected by a temporary increase in the count rate. Depending on the acceptable Background Induced False Alarm Rate (BIFAR) the counts must exceed the mean by some multiplier of the standard deviation. This method works well, but assumes that the shape of the distribution tail is totally determined by the mean of the distribution. It is not always clear that this is the case when looking at situations 6, 7, 8 or 10 standard deviations from the mean.

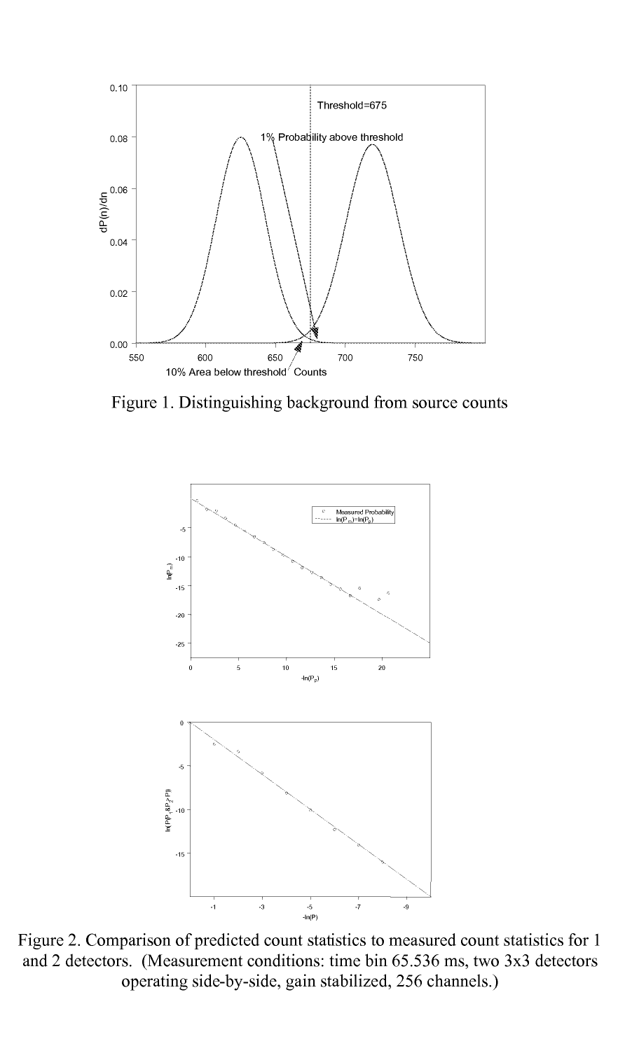

The basic hit detection situation is illustrated in FIG. 1. In this example the mean background counts for the counting interval is 625. For source counts to be considered a hit, the number of counts must be above some threshold. The signal+background counts also follow Poisson statistics. Depending on how the threshold is set, more background fluctuations are accepted to get a smaller required count rate for the source counts. Reducing BIFA by increasing the threshold increases the detectable number of source counts. In this example, the threshold is set so that 1% of the background counts are above the threshold. This means that in 1% of the interrogations background counts alone will exceed the threshold. If this situation represents an interrogation rate of 1 Hz (counting time of 1 second) there would be a BIFA about every 100 seconds.

In the pass-by situation, a vehicle mounted source moves pass the detector in less than one second. The number of counts is low, so the system must be very sensitive. This implies a low threshold. However, the system must have a very low BIFAR, otherwise its information will be discredited and the system will be ignored. The challenge in this situation is to obtain high sensitivity with a low false alarm rate.

In a normal γ-ray counting measurement, the minimum detectable counting rate can be reduced by changing some parameters in the problem. The counting time can be increased, the detector solid angle increased, or the background suppressed. In a pass-by measurement there is little control over counting time, as the vehicle speed and detector-source distance are controlled by the driver. The detector solid angle is determined by available detectors, and vehicle distance. However, the usefulness of field measurements can be enhanced by using signatures not normally associated with γ-ray counting. In a pass-by mode, sensitivity can be increased through suppression of background, and also by using the differences between background statistics and source statistics.

1.1. Background Counts vs. Source Counts
1.1.1. Energy Resolution

With energy-resolving detectors, such as a NaI detector, source counts tend to be clump around the photopeak. The background probability distribution is typically very different from a source count distribution. Instead of comparing count fluctuations to total background fluctuation, the fluctuations over a very small number of channels can examined. A fluctuation over the small number of channel requires fewer counts to be statistically significant. This requires fewer counts, hence allowing weaker sources, to be recognized as a source detection.
1.1.2. Multiple-detector Correlations

From the mean number of background counts in an energy bin, the probability of obtaining n counts in each channel from background alone can be calculated. If the count statistics of the NaI detector actually follow Poisson statistics, the predicted probability (Pp) should be equal to the measured probability (Pₘ). The results of such a measurement are shown in FIG. 2. The measured probability follows the prediction quite well, until the e⁻¹⁷ (4×10⁻⁸) level is reached. At that point values of n occur with much greater frequency than expected from simple counting statistics. Unfortunately this is about the desired detection threshold level. This deviation forces any single detector, single time slice method to have a much higher than expected threshold to avoid a high BIFAR. This higher threshold reduces system sensitivity.

If these non-Poissonian events are correlated between detectors, then a two detector plot would look similar to a one detector plot. The measured probability would show a deviation from the predicted probability at the lower probability events. If there were no correlation between the two detectors due to background, then the probability that both detectors simultaneously experienced an event exceeding some threshold in the same time slice and the same channel would be the simple relationship P(d1>p, d2>p)=P², where P is the predicted single detector probability of exceeding a threshold given from Poisson statistics. If the low probability background fluctuations were correlated between detectors, then a two detector plot would show a deviation similar to the one detector plot. In FIG. 2 is the measured two detector probability of both detectors exceeding a probability. Practitioners of ordinary skill will recognize that this approach can be extended to multiple detectors.

The one and two detector statistics were compiled at the same time, so the one detector non-Poissonian events of FIG. 2 are contained in data used to generate the two detector plot. Since non-Poissonian fluctuations are not present in the two detector data of FIG. 2, it is clear that the fluctuations do not occur in the two different detectors in the same time slice. This plot shows that the measured probability does not deviate from the predicted Poisson statistics. This means that the low probability background events that could be confused with a source event do not correlate between detectors. This allows us to use the multiple detectors to filter out the anomalous high count events, and set lower thresholds, giving greater sensitivity.

Similar measurements have been made for multiple time slices. Background fluctuations of a given energy do not correlate from time slice to time slice. If an increase in count is recorded in time bin n there is no greater probability for an increased number of counts in time bin n−1 or n+1. When a source passes the detector an increased count in energy bin 1 in time bin n implies an increased number of counts in energy bin 1 in time bin n+1.

The following differences between background counts and source counts are exploited to produce a system very sensitive to the passage of a source:

1. The energy distribution between background and source counts is very different,

2. Source count fluctuations correlate between detectors, background counts do not, and

3. Source count fluctuations correlate from time slice to time slice during a source passage, while background fluctuations do not.
1.1.3. Sensitive Source-detection Algorithm

The relationship between the mean, standard deviation, BIFAR and false negative rate is given by

$${R}_{b} τ + {Z}_{FP} \sqrt{{R}_{b} τ} = ( {R}_{b} + {R}_{s} ) τ - {Z}_{FN} \sqrt{( {R}_{s} + {R}_{b} )} τ$$

where R_{b} is the background rate, τ is the counting time, Z_{FP} is the standard deviation multiplier that gives the desired False Positive (Or false alarm) rate, Z_{FN} is a multiplier that determines the rate of false negatives (misses) that are of interest, and Rₛ it the source count rate that meets the requirements. This is the formula for the situation shown in FIG. 1. Solving for Rₛ gives

$${R}_{s} = \frac{{Z}_{FN} \sqrt{( {R}_{b} + {R}_{s} )} + {Z}_{FP} \sqrt{{R}_{b}}}{\sqrt{τ}}$$

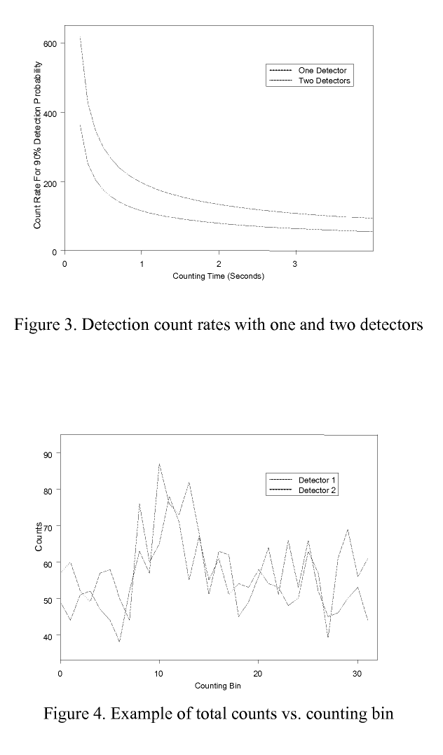

Using two or more detectors provides greater sensitivity by allowing the use of correlated fluctuations. As illustrated in FIG. 2, background fluctuations do not correlate between detectors. This implies that each detector threshold can be reduced without reducing the overall False Positive rate. From the equation, the minimum detectable count rate as a function of dwell time can be calculated. For a 90% probability of detection, the false negative factor giving 90% probability of detection is 2.1 (Z_{FN}=2.1). This can be found by consulting a standard cumulative normal look-up table. A typical false positive rate of 10⁻⁶ is used, so Z_{FP} is typically set to 6 (for six-sigma significance). Since background fluctuations do not correlate between detectors, if two detectors are used, the same false positive rate can be obtained by setting Z_{FP} to 3. A comparison of count rates resulting when using one and two detectors is shown in FIG. 3.
1.1.4. Multiple Time Slices

For a detector system the threshold can be set by looking for count fluctuations consistent with a source passage. This means that the size of the time slice should be less than half of the time required for passage of a source. In this way, multiple time slice correlations can be used to discriminate against the non-Poisson background fluctuations. The threshold can be set using the formula.
1.1.5. Derivation of Source-detection Formula

All source detection algorithms operate by observing some difference between background counts and background plus source counts. The standard method used is to observe an increase in counts that is unlikely to be due to background alone. If counts in a given time are some multiple of the average background fluctuation the event is deemed to be unlikely to be due to background alone, and a source is considered to have been detected. This straightforward looking for an increase in counts is a fine method when sources are strong, background is low, counting time is unlimited or the false alarm rate is irrelevant. In the portal monitoring environment source are weak, background is fixed, counting time is fixed and the false alarm rate must be kept low. The approached used to meet the requirements in the portal monitoring environment is still the same: count distributions that are unlikely to be due to background alone are identified. The source detection algorithm looks for count strings in time lengths appropriate for the passage of a source unlikely to be due to background counts alone.

As an example of how the source detection algorithm operates assume that for some set of conditions 6 time bins of width At are required for the source to pass by the detectors. Also assume that for the detector background that there is a probability of 0.1 that a count occurs in any given time bin, and 0.9 that no counts occur in a time bin, and that the probability of obtaining more than 1 count is zero. The probability of only one count occurring in the 6 consecutive time bins is 6(0.1)(1−0.1)⁵=0.35. So with P(0)=0.9, and P(1)=0.1, about 35% of the time one count could be expected from background alone. Similarly the probability of obtaining more counts during this period could be calculated using the formula

$$P ( c ) = \frac{6 !}{( 6 - c ) ! c !} {( 0.1 )}^{c} {( 0.9 )}^{6 - c} .$$

These probabilities are given in Table 1.

Table 1. Probability of Obtaining More Counts During Period.

| Number of | |
|---|---|
| Counts-c | P(c) |
| 0 | 0.53 |
| 1 | 0.35 |
| 2 | 0.098 |
| 3 | 0.0146 |
| 4 | 1.22 × 10⁻³ |
| 5 | 5.4 × 10⁻⁵ |
| 6 | 10⁻⁶ |

If counts from one time bin to the next are uncorrelated the probability of obtaining six counts in a row is 10⁻⁶ Probabilities at this level are low enough that they are typically accepted as evidence of the presence of a source. The source detection algorithm operates by looking for strings of counts whose probability of occurrence due to background alone is so low that they are judged to be due to source plus background.

The source detection algorithm utilizes the energy discriminating ability of the spectroscopic detector, and the observed independence of background count fluctuations between detectors. The source detection algorithm uses multiple energy bins. The bin widths are appropriate for a photo peak of the particular energy. The energy bins are narrow for low energy peaks, and wider for higher energy peaks. This accommodates the increase in peak width with energy seen with NaI detectors. For a detection to be declared a count fluctuation must be observed in both detectors, in the same energy bin, over the same time interval.

The number of time bins used depends on the time it takes for the source to pass through the field of view of the detector. The number used is dependant upon vehicle speed and distance. The variation in source speed and distance is accommodated by checking a range values which encompass the range of values expected in a given situation. For a high speed corridor monitor the values chosen would be from about 0.3 seconds to 1 second, as this is a typical range of time a source is in the field of view of the detector. For a portal monitor times from 1 second to 6 seconds are more appropriate.

The hit detection algorithm is implemented by answering the question “For a given false alarm rate, what individual threshold probability must be exceeded to result in the desired probability of false alarm”. For a single channel, this can be written as

$${P}_{fa} = \frac{N !}{( N - h ) ! h !} {{P}_{th}^{h} ( 1 - {P}_{th} )}^{N - h} .$$

Where P_{fa} is the desired probability of false alarm, N is the number of time bins considered, h is the number of these bin with counts above threshold, and Pₜₕ is the threshold probability that will provide the desired false alarm rate. For a spectroscopic detector with multiple energy bins there will be N_{eb} comparisons. This changes the one channel formula to

$${P}_{fa} = {N}_{eb} \frac{N !}{( N - h ) ! h !} {{P}_{th}^{h} ( 1 - {P}_{th} )}^{N - h} .$$

With multiple detectors the background fluctuations are assumed to be independent; this has been observed in data (see previous section). Since the background fluctuations between detectors are considered to be independent for a desired overall system false alarm rate of P_{fa} the individual detector false alarm rate would go as P^{1/N}_{^{d}}_{fa}, where N_{d} is the number of detectors. Since background fluctuations are independent from detector to detector, this is saying simultaneous fluctuations of 10⁻³ in the same energy bin in both detectors during the same time interval are equivalent to an overall system fluctuation with probability of 10⁻⁶. This changes the single detector, multiple energy bin formula to

$${P}_{fa}^{1 / {N}_{d}} = {N}_{eb} \frac{N !}{( N - h ) ! h !} {{P}_{th}^{h} ( 1 - {P}_{th} )}^{N - h} .$$

This is the relationship between the desired false alarm rate (P_{fa}) and the required probability threshold (Pₜₕ). Solving this relationship for Pₜₕ gives

$${P}_{th} = {( \frac{( N - h ) ! h !}{{N}_{eb} N !} \frac{{P}_{fa}^{1 / {N}_{d}}}{{( 1 - {P}_{th} )}^{N - h}} )}^{1 / h} .$$

The term (1−Pₜₕ) is always less than one, and Pₜₕ is typically a small number. Setting this term equal to one is conservative from the standpoint of background induced false alarm. Using this approximation results in an easily solved formula

$${P}_{th} = {( \frac{( N - h ) ! h !}{{N}_{eb} N !} {P}_{fa}^{1 / {N}_{d}} )}^{1 / h} .$$

The detector does not measure probabilities; it measures counts. To determine the probability of a given number of counts in a time bin from background the Poisson distribution is used. The probability of obtaining n counts in energy bin k is given by

$${P}_{k} ( n ) = \frac{{μ}_{k}^{n} {ⅇ}^{- {μ}_{k}}}{n !} ,$$

where μₖ is the mean number of background counts in energy bin k. For use in the hit detection formula, the probability of exceeding the count threshold is required. The probability of obtaining n or more counts in energy bin k (background mean=μₖ) is

$${P}_{k} ( \geq n ) = {\sum }_{m = n}^{+ ∞} \frac{{μ}_{k}^{m}}{m !} {ⅇ}^{- {μ}_{k}} = 1 - {\sum }_{m = 0}^{m = n - 1} \frac{{μ}_{k}^{m}}{m !} {ⅇ}^{- {μ}_{k}} .$$

This is the formula used to calculate the probability used to compare to the threshold probability.

Multiple Time Slices

For a detector system the threshold can be set by looking for count fluctuations consistent with a source passage. This means that the size of the time slice should be less than half of the time required for passage of a source. In this way, multiple time slice correlations can be used to discriminate against the non-Poisson background fluctuations. The threshold can be set using the formula

$${P}_{fa} = {[ C \frac{n ! {{P}_{th}^{h} ( 1 - {P}_{th} )}^{n - h}}{( n - h ) ! h !} ]}^{{N}_{d}}$$

Where P_{fa}=probability of false alarm; C=number of channels in the spectra, n=number of time slices for source passage, h=number of slices out of the n slices above the threshold, Pₜₕ=threshold probability and N_{d}=number of detectors.

Since the threshold probability is typically very small, 1−Pₜₕ≈1, so this formula can be rewritten as

$${P}_{fa} = {[ C \frac{n ! {P}_{th}^{h}}{( n - h ) ! h !} ]}^{{N}_{d}}$$

The BIFAR false alarm rate is given as
R_{fa}=P_{fa}R₁

where R_{fa}=false alarm rate and

R_{I}=interrogation rate.

Solving for the threshold gives

$${P}_{th} = {[ \frac{( n - h ) ! h ! {P}_{fa}^{1 / {N}_{d}}}{Cn !} ]}^{1 / h}$$

The number of time slices considered (n) is dependant upon the time the source is expected to be in the field of view. The hit detection system goes through the n time slices, and C energy bins to see if in any of these there were a sufficient number of counts above threshold to be considered a hit.

The parameters that go into the system design are number of detectors, amount of background shielding, allowed BIFAR, and acceptable sensitivity. These decisions are influenced by the time the source is in the field of view of the detector(s), which is a function of the source speed and distance. Clearly cost (acquisition and operation), portability, and system reliability are all involved in this process.

### EXAMPLE OF HIT DETECTION

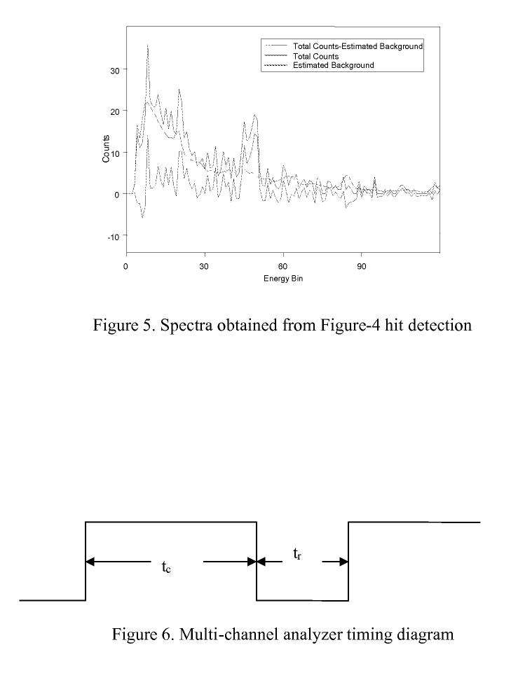

The use of this system is illustrated in FIG. 4. In this example a weak ¹³⁷Cs source was driven by a two detector system utilizing the multiple time slice correlation technique. The total counts recorded by the detector are shown in FIG. 4. While there is a small count fluctuation around time bins 10-15, there are no counts that approach the 6 sigma level, and few that exceed the 3-sigma level. However, the system detected the source, with the threshold set to give a false positive rate of 10⁻⁷. This detection was made on γ-ray counts alone; no secondary signatures such as an occupancy monitor were used.

The spectra obtained from the pass-by shown in FIG. 4 are shown in FIG. 5. This spectrum was obtained by summing the 18 time slices identified by the two detectors as containing anomalous counts. This figure shows the extreme sensitivity of the method, as only one or two additional counts were present in the photopeak during an average time slice, yet the system was able to identify the passage of the source.

Equipment

Three types of radiation detectors—NaI(Tl) and plastic gamma scintillation detectors and He-3 tubes for neutron detection—were deployed in various groups in the testbed. The detectors were deployed along the side of public highways and waterways. Typical separation between the detectors and the center of the driving lane nearest the detector was 3-5 meters. For this demonstration, detectors were placed along only the inbound traffic lane. The two outermost stations consisted of two combined NaI detectors, a plastic scintillation detector, and a neutron detector. Closer-in stations utilized plastic detectors alone. The outermost sites provided real-time source isotope ID. Inner sites were used to track a source after an ID. Each site also had detector-triggered cameras, which provided source vehicle identification.

NaI(Tl) detectors provide isotope ID capability. NaI detector systems are simple to use, can be operated in hands-off mode for considerable periods of time, and provide the largest detection area at lowest cost of all energy-sensitive detectors. Plastic scintillation detectors provide a large detector area at relatively low cost, but with no spectral discrimination. These detectors provide a source-tracking capability at stand-alone stations. Because there are very few legitimate sources of neutrons, the neutron detectors provide strong evidence of the passage of fissionable material.

In addition to the radiation detection system, a communication and control system was implemented. This system transferred data from the 12 sensor sites to a central control station, where the radiation detections were monitored. Electronic images of passing vehicles, taken by cameras activated by the radiation detectors, were displayed. The system was comprised of computers, typical desktop computers connected over a data network. Software running on the computers accepted the court data from the detectors, processed the data in accordance with the invention and then generated control messages for the cameras as well as updating status display.

NaI Detectors

Since a source identification was required, the output of the NaI(Tl) detector was connected to a Multi-Channel Analyzer (MCA). A Canberra ASA-100 was used for this purpose (reference 1). For an MCA to be effective, it must acquire counts for some period of time (t_{c}). The ASA-100 cannot simultaneously acquire and upload counts, so the acquisition must be interrupted to move the count information from the MCA card to the internal memory of the computer. During this reset time (tᵣ) count acquisition is stopped, the counts are loaded to the computer memory, the MCA is reset, and acquisition is restarted (FIG. 6).

In a pass-by, the time that the source will be near the detector is short. Optimum signal to noise occurs when the source is in the ±45° field of view of the detector. Typical standoff distances on a public roadway are about 3-5 m. For a source moving at 30 m/s (˜67 MPH), the optimum counting time is ˜0.2-0.3 seconds. Since the source passes the detector at random times, keeping t_{c} less than the total transit time optimizes the signal to background ratio.

These requirements define the system design parameters. Counting time (t_{c}) must be less than the typical source transit time (˜0.2-0.3 seconds). The ratio of the reset time (tᵣ) to the counting time must be small, or else the system will be spending an unacceptable amount of time resetting rather than obtaining counts. The MCA control software was designed to balance these requirements. In the field system, acquisition time was about 125 ms, and reset time was reduced to 22 ms.

A two-detector system was used. Each detector package has different gain characteristics, so a separate MCA is required for each detector. The acquisition times of the two detectors were phased relative to one another, so at least one detector was always counting. Correlations between the two detectors were used to discriminate source counts from background counts. In the event of a source passage, the counts from the two detectors were combined to provide better isotope identification.

Spectra obtained from the MCA's are checked for events that are not likely to have come from background fluctuations. In the short interaction time used, the relative fluctuations of counts in any given channel are quite large. Passing sources give rise to count fluctuations. The differences between normal background count fluctuations and count fluctuations due to passing sources are used to discriminate source counts from background counts.

Background fluctuations have three main features that are important for this system.

1) Background fluctuations are not correlated with respect to channel number—if there is a count in channel i there is no greater probability of a count appearing in channel i−1 or channel i+1;

2) Background fluctuations are not correlated with respect to time slice—if there is a count in channel i during time slice j then there is no greater probability of a count appearing in time slice j−1 or j+1;

3) Background fluctuations are not correlated with respect to detector—if there is a count in channel i of detector 1 here is no greater probability of there being a count in channel i of detector 2.

Counts from sources follow different patterns from background counts

1) Source counts tend to group around the source photopeak; there exists a channel or group of channels where source counts are more likely to occur, depending on the energy of the source.

2) Source counts arrive only during time slices which the source was close to the detector; for 2-3 time slices if there are counts in channel i during time slice j, there will be a greater probability of counts occurring during time slice j−1 or j+1;

3) Source counts are correlated from detector to detector; if counts from a source occur in channel i of detector 1, there is a greater probability of counts occurring in channel i of detector 2.

The NaI analysis algorithm used here looks for correlations unique to source counts. When events with a high degree of correlation consistent with source counts appear, they are counted as a source. The power of the technique is that the probability of the patterns caused by □ray sources occurring as a result of background fluctuations are so small as to be non-existent.

Analysis Algorithm

In a given channel, the mean number of counts expected from background during a time slice is given by Poisson statistics

$${P}_{i} ( n ) = \frac{{( {r}_{i} τ )}^{n} {ⅇ}^{- {r}_{i} τ}}{n !} \qquad Equation 1$$

where Pᵢ(n) is the probability of obtaining n counts in channel i, rᵢ is the background rate of channel i, τ is the counting time of the time slice, and n is the number of counts in channel i. The hit detection algorithm takes the number of counts in a channel and calculates the probability that the counts came from background. If the probability is below some threshold, it is assumed that the counts did not come from background, that is, the counts came from a nearby radioactive source.

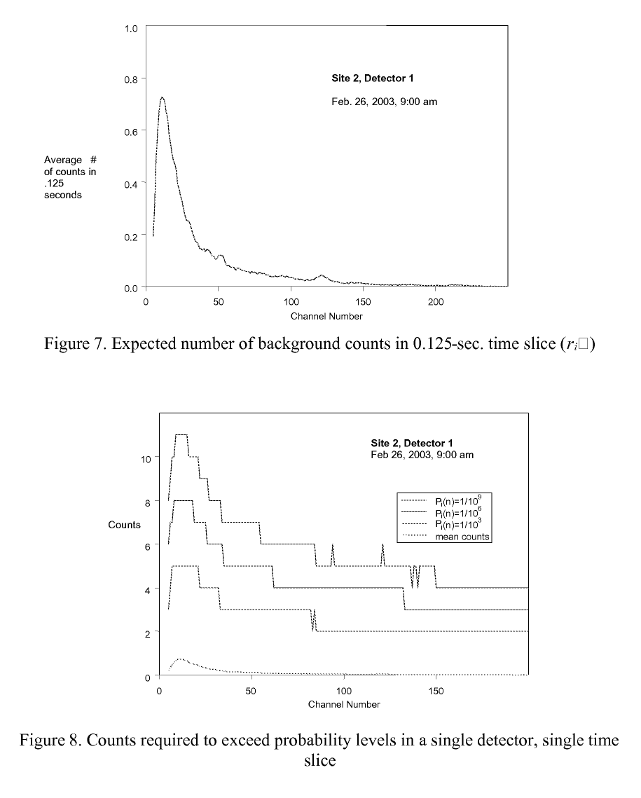

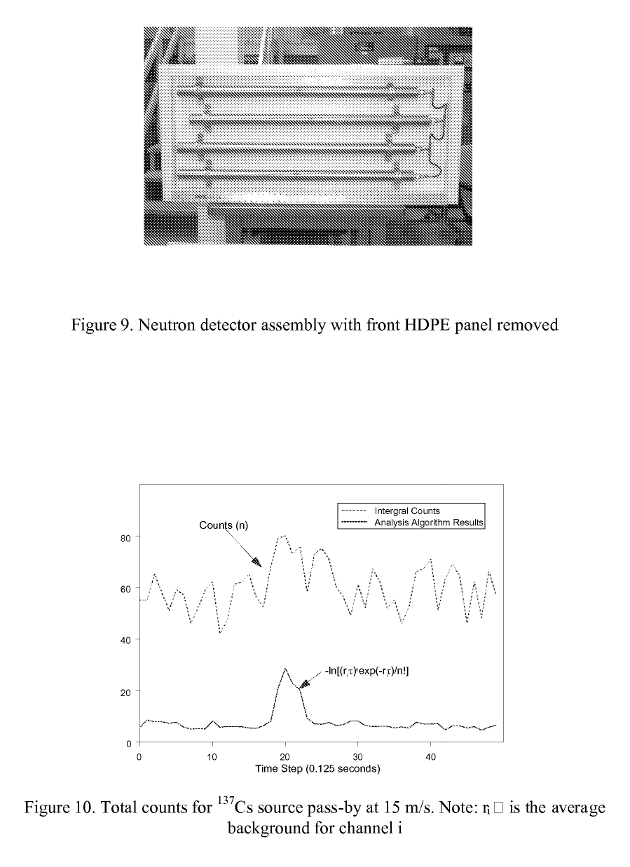

For illustration, consider the background shown in FIG. 7. Background was accumulated over 1000 seconds, and scaled to give the expected number of counts in a 0.125 second time slice. Note that for this particular detector, at this particular time, the expected number of background counts in a 0.125 second time slice is less than one in all channels. These are the values of riτ used in Equation 1. A spectrum is checked by using the actual number of counts (n in Equation 1) that occurred in each bin (i) during a time slice. If the probability is so small as to be unlikely to be from background fluctuation, a source encounter is considered to have happened. The number of counts required to exceed various probability levels is shown in FIG. 8.

The sensitivity of the system is increased by using correlations across time slices and across the energy spectra. Background fluctuations do not correlate from one time slice to the next. Time correlations are seen only while a radioactive source is passing in front of the detector. Events with a low probability due to background fluctuations that repeat from time slice to time slice are a unique signature of a passing radioactive source.

Most photopeaks occur in more than one channel. When a source is present, the counts over a region of bins increase. This is another signature unique to radioactive sources. The width of a peak varies with bin number. The larger the bin number, the wider the peak. The analysis program looks for anomalous numbers of counts over regions consistent with the width of a photopeak.

Plastic Scintillators

Commercial detectors (reference 2), used in a gross counting mode, were placed along the roadway. The plastic detectors provided a verification of NaI isotope reports in the two stations where NaI, Plastic and Neutron detectors were deployed. Other stations consisted of only plastic detectors. Here the detectors provided tracking of a previously identified vehicle. Traffic cameras were used at all sites, providing source-vehicle identification. Detector count accumulation time was 100 ms. If counts in any interval were above a threshold, a radiation hit was reported.

Neutron Detectors

The neutron detectors consisted of ³He tubes (reference 3). Four He-3 tubes are enclosed in a high-density polyethylene (HDPE) box (FIG. 10). The thickness of the box sides and rear are 2 inches and the front panel is about 0.5 inches (reference 4). As with the plastic detectors, a 100-ms counting interval was used. A neutron event is triggered when counts from a single time interval exceed a selected threshold.

System Testing and Results

The system was tested against sources moving at traffic speeds (typically from ˜20 m/s-27 m/s). Under the conditions described, the system proved capable of detecting several test sources (activity levels on the order of tens of μCi) and making correct identifications. The system also detected numerous events believed to be due to medical sources in vivo of a small fraction of the motoring public. The system identified these simply as “other”, i.e. not any of the test set. The source library is being expanded to accommodate such detections in system upgrades.

The power of the hit-detection algorithm is shown in FIG. 10. A ¹³⁷Cs source was used in this pass-by test. In the integral counts vs. time display (FIG. 10), there is no clear interaction. The rise and fall of counts could be due to background fluctuations.

The probability that the counts in a particular channel were due to background alone was calculated. At the peak of the analyzed data shown in FIG. 10, the probability that the counts in a particular channel were due to background is about e⁻³⁰, or about 10⁻¹³. With the 8 Hz sampling rate, 40,000 years of sampling is expected before encountering a fluctuation like this from background alone. This occurrence is a rare enough that such an event must have been caused by the passage of a radioactive source.

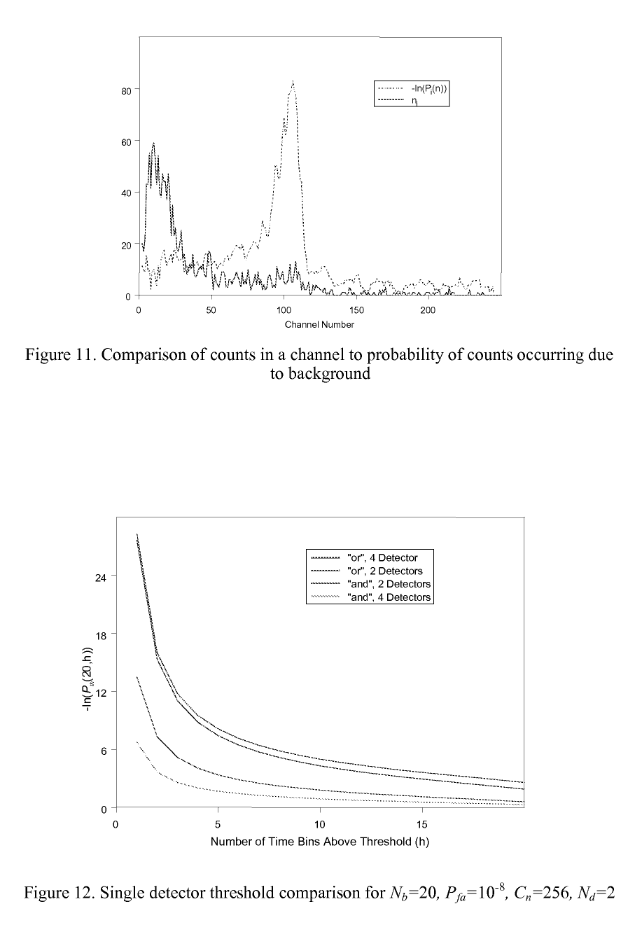

Channels in which low probabilities occur are clustered about the photopeak of the γ ray. The γ ray energy causing the fluctuation is then known, which provides the isotope identification. An example of this is shown in a ⁶⁰Co encounter (FIG. 11). For this detector gain setting the ⁶⁰Co 1173 keV peak occurs at ˜channel 98, and the 1333 keV peak occurs at ˜channel 109. Total counts (nᵢ) are shown in FIG. 11, along with the probability of obtaining the counts from background (−ln(Pᵢ(n)). The centroid of the counts in these channels is then found, and an identification of the isotope causing the count fluctuation can be made. Note that the normal statistics associated with peak identification are still applicable. Centroid error is still dependent on the number of counts in the peak.

A radiation detection system has been assembled and fielded along a public roadway. The system proved capable of detecting and identifying low level sources carried in passenger vehicles moving at speeds of 30 m/s (˜70 mph). The system couples an 8-10 Hz sampling rate, high sensitivity and a very low false alarm rate due to background fluctuations. The system has gone through an extensive testing regimen through its demonstration phase. During testing on the public roadway, many radioactive sources not part of the demonstration testing were detected. The system library is now being upgraded to provide a more extensive range of source identifications.

Higher Sensitivity Threshold Calculations.

Consider the situation where a source passes the detectors, and requires some time τ to pass though the detector field of view. Assume that the detectors divide τ into sub-time bins, so the count information is divided into N_{b} bins. What count threshold probability must be set in an individual time bin so that the overall probability of event from background fluctuation alone is below some false alarm rate?

Assume the single detector, single time bin threshold count probability is Pₜₕ, and the threshold counts are nₜₕ. This means that the probability of obtaining nₜₕ or more counts from background alone in time τ_{b}, where τ_{b}=−τ/N_{b} is less than Pₜₕ. The desired background induced false alarm rate is P_{fa}. This means that the probability of the source detection event occurring from background counts alone is P_{fa}. If the source is in the field of view for N_{b} time bins, the threshold probability can be calculated from the relationship P_{fa}=Pₜₕ^{N}_{^{b}}, or P_{fa}^{1/N}_{^{b}}=Pₜₕ . The condition for detection is defined as counts from N_{b} consecutive time bins in a single detector are above a threshold. For a desired false alarm rate the threshold for a given false alarm rate is found.

Single Detector System

A more sensitive system might arise if the condition for source detection was relaxed. Consider the situation where an event is considered to occur if counts in the detector are above threshold for h of the N_{b} time bins. In N_{b} time bins there are

$$\frac{{N}_{b} !}{( {N}_{b} - h ) ! h !}$$

ways to arrange h above threshold events in N_{b} time bins. The relationship between the desired false alarm rate and threshold becomes

$${P}_{fa} = \frac{{N}_{b} !}{( {N}_{b} - h ) ! h !} {{P}_{th}^{h} ( 1 - {P}_{th} )}^{{N}_{b} - h}$$

Since the relationship Pₜₕ<<1 typically is true, the formula can be simplified to

$${P}_{fa} \approx \frac{{N}_{b} !}{( {N}_{b} - h ) ! h !} {P}_{th}^{h}$$

The relationship between P_{fa} and the threshold probability to give P_{fa} is

$${P}_{th} ( {N}_{b} , h ) \approx {( \frac{( {N}_{b} - h ) ! h ! {P}_{fa}}{{N}_{b} !} )}^{1 / h}$$

In a spectroscopic detector more than one energy bin is considered. The background fluctuations from each energy bin are considered to be independent. If there are Cₙ energy bins, the relationship between false alarm rate and threshold is

$${P}_{fa} \approx \frac{{C}_{n} {N}_{b} !}{( {N}_{b} - h ) ! h !} {P}_{th}^{h}$$

$${P}_{th} ( {N}_{b} , h ) \approx {( \frac{( {N}_{b} - h ) ! h ! {P}_{fa}}{{C}_{n} {N}_{b} !} )}^{1 / h}$$

Two Detector Systems- “and” Setting

With multiple detectors there is some flexibility in the conditions considered to signify an event. In this situation the threshold probability setting required to obtain a given false alarm rate will be calculated if the detection condition is counts from both detectors must be above threshold.

The single detector, single time bin threshold probability is Pₜₕ. The probability counts from all N_{d} detectors are above threshold in a given time bin is P(N_{d}>Pₜₕ)=(Pₜₕ)^{N}_{^{d}}. This follows from the assumption that background count fluctuations are considered to be independent from detector to detector. Substituting this into the relationship between false alarm rate and Pₜₕ for multiple time bins gives

$${P}_{fa} = \frac{{N}_{b} !}{( {N}_{b} - h ) ! h !} {{P}_{th}^{{N}_{d} h} ( 1 - {P}_{th}^{{N}_{d}} )}^{{N}_{b} - h}$$

With Pₜₕ<<1 the relationship between P_{fa} and Pₜₕ is

$${P}_{th} ( {N}_{b} , h ) \approx {( \frac{( {N}_{b} - h ) ! h ! {P}_{fa}}{{C}_{n} {N}_{b} !} )}^{1 / {N}_{d} h}$$

Two Detector Systems- “or” Setting

In this case the detection condition is counts from either detector are above threshold. The relationship between P_{fa} and Pₜₕ will be calculated and compared to the previously discussed “and” condition.

If Pₜₕ is the threshold probability, the probability counts in one detector are below the threshold is 1−Pₜₕ. The probability that counts from all N_{d} detectors are below threshold is P(N_{d}<Pₜₕ)=(1−Pₜₕ)^{N}_{^{d}}. The probability that at least one of the N_{d} detectors has a count above threshold is P(C>0)=1−(1−Pₜₕ)^{N}_{^{d}}, where C is the number of detectors with counts above threshold. If the condition for an event is that for N_{b} consecutive time bins at least one detector has counts above threshold, the relationship between false alarm rate and threshold probability is

$${P}_{fa} = {[ 1 - {( 1 - {P}_{th} )}^{{N}_{d}} ]}^{{N}_{b}}$$

$$or$$

$${P}_{th} = 1 - {( 1 - {P}_{fa}^{1 / {N}_{b}} )}^{1 / {N}_{d}}$$

If the situations where h out of the N_{b} time bins channels are above threshold for a source detection to occur is considered, the formula becomes somewhat clumsy. Let χ=(1−Pₜₕ)^{N}_{^{d}}. The value χ is the probability that the counts of all detectors are below threshold.

The relationship between χ and P_{fa} in a spectroscopic detector with Cₙ channels is

$${P}_{fa} = {C}_{n} \frac{{{N}_{b} ! [ 1 - χ ( {N}_{b} , h ) ]}^{h} {χ ( {N}_{b} , h )}^{{N}_{b} - h}}{( {N}_{b} - h ) ! h !}$$

Solving for χ gives

$$\frac{{P}_{fa} ( {N}_{b} - h ) ! h !}{{C}_{n} {N}_{b} !} = {[ 1 - χ ( {N}_{b} , h ) ]}^{h} {χ ( {N}_{b} , h )}^{{N}_{b} - h}$$

Since χ=(1−Pₜₕ)^{N}_{^{d}}, it will typically be a number very close to one. Using this approximation gives

$${[ \frac{{P}_{fa} ( {N}_{b} - h ) ! h !}{{C}_{n} {N}_{b} !} ]}^{1 / h} = 1 - χ ( {N}_{b} , h )$$

$$1 - {[ \frac{{P}_{fa} ( {N}_{b} - h ) ! h !}{{C}_{n} {N}_{b} !} ]}^{1 / h} = χ ( {N}_{b} , h )$$

$$or$$

$$1 - {[ \frac{{P}_{fa} ( {N}_{b} - h ) ! h !}{{C}_{n} {N}_{b} !} ]}^{1 / h} = {( 1 - {P}_{th} ( {N}_{b} , h ) )}^{{N}_{d}}$$

Simplifying gives

$${( 1 - {[ \frac{{P}_{fa} ( {N}_{b} - h ) ! h !}{{C}_{n} {N}_{b} !} ]}^{1 / h} )}^{1 / {N}_{d}} = 1 - {P}_{th} ( {N}_{b} , h ) , \\ or$$

$$1 - {( 1 - {[ \frac{{P}_{fa} ( {N}_{b} - h ) ! h !}{{C}_{n} {N}_{b} !} ]}^{1 / h} )}^{1 / {N}_{d}} = {P}_{th} ( {N}_{b} , h )$$

The value of P_{fa} is typically very small, usually ˜10⁻⁶ to 10⁻⁸. This makes

$$[ \frac{{P}_{fa} ( {N}_{b} - h ) ! h !}{{C}_{n} {N}_{b} !} ]$$

a very small number. To within the capabilities of double precision arithmetic on a 32 bit computer Pₜₕ(N_{b}, h) is given by

$${P}_{th} ( {N}_{b} , h ) \approx y ( 1 + y ( \frac{{N}_{d} - 1}{2} ) + {y}^{2} \frac{( {N}_{d} - 1 ) ( 2 {N}_{d} - 1 )}{6} + K )$$

where

$$y = {\frac{1}{{N}_{d}} [ \frac{{P}_{fa} ( {N}_{b} - h ) ! h !}{{C}_{n} {N}_{b} !} ]}^{1 / h}$$

To first order, the relationship between threshold and false alarm in the “or” situation is given as

$${P}_{th - or} ( {N}_{b} , h ) = {\frac{1}{{N}_{d}} [ \frac{{P}_{fa} ( {N}_{b} - h ) ! h !}{{N}_{b} ! {C}_{n}} ]}^{1 / h}$$

Contrast this with the previously used “and” situation, where all detectors were required to be above threshold in a time bin. This relationship is

$${P}_{th - and} ( {N}_{b} , h ) = {[ \frac{{P}_{fa} ( {N}_{b} - h ) ! h !}{{N}_{b} ! {C}_{n}} ]}^{\frac{1}{{hN}_{d}}}$$

While not immediately obvious, the thresholds in the “and” situation are lower than the “or” situation for a given N_{b} and h. A comparison of the thresholds required to achieve a given false alarm rate is shown in FIG. 12.

Detection Implications of “and” vs. “or”

The “and” vs. “or” strategy affects the probability of detection. The impact of the definition of what constitutes detection on the relationship between source detection rate rₛ vs. probability of detection P_{d} will be considered.

In the development of the threshold probability three assumptions of background independence were made. In this section some assumptions about the counts required to achieve detection are made. For purposes of discussion all detectors are assumed to see the same background, and have the same field of view of the source. In a real situation, for side by side detectors, this is a good assumption.

With the relatively few counts in an energy bin of a spectroscopic detector, a discrete Poisson approach must be used to find the relationship between Pₜₕ and nₜₕ, the threshold number of counts. The probability that a source with scattering rate rₛ gives an above threshold number of counts in an energy bin with average background rate r_{b} in counting time τ_{b} is

$$P ( n > {n}_{th} ) = 1 - {\sum }_{k = 0}^{k < {n}_{th}} \frac{{( ( {r}_{s} + {r}_{b} ) {τ}_{b} )}^{k}}{k !} {ⅇ}^{- ( ( {r}_{s} + {r}_{b} ) {τ}_{b} )}$$

The probability of source detection is P_{d}. Consider the simple case where there must be N_{b} events above threshold in N_{b} consecutive time bins to declare an event. The detection probability is then P_{d}=P(success)^{N}_{^{d}}, where P(success) is the probability that the single time bin conditions for a detection have been meet.

P_{d} for “and” Relationship

In the “and” relationship the condition for detection is that all detectors have counts above threshold. The single time bin success probability is P(success)=P(n>nₜₕ_{_{—}}_{and})^{N}_{^{d}}, where nₜₕ_{_{—}}_{and} is the threshold number of counts using the “and” Pₜₕ. For N_{b} time bins the detection probability is P_{d}=P(n>nₜₕ_{_{—}}_{and})^{N}_{^{d}}^{N}_{^{b}}. The source must then meet the condition P_{d}^{1/N}_{^{d}}^{N}_{^{b}}=P(n>nₜₕ_{_{—}}_{and}).

P_{d} for “or” Relationship

In the “or” relationship the single time bin probability of success is a bit more complex. The probability of a failure (or a not-success) is the probability none of the detectors have a count above the threshold level. This probability is P(fail)=(1−P(n>nₜₕ_{_{—}}ₒᵣ))^{N}_{^{d}}, where nₜₕ_{_{—}}ₒᵣ is the “or” threshold count. The single time bin probability of success is P(success)=1−P(fail)=1−(1−P(n>nₜₕ_{_{—}}ₒᵣ))^{N}_{^{d}}. The detection condition in N_{b} time bins is to have N_{b} consecutive successes, so the probability of detection is P_{d}=[1−(1−P(n>nₜₕ_{_{—}}ₒᵣ))^{N}_{^{d}}]^{N}_{^{b}}. The relationship between the count probability and source detection is

$$P ( n > {n}_{th\_or} ) = 1 - {( 1 - {P}_{d}^{1 / {N}_{b}} )}^{1 / {N}_{b}} .$$

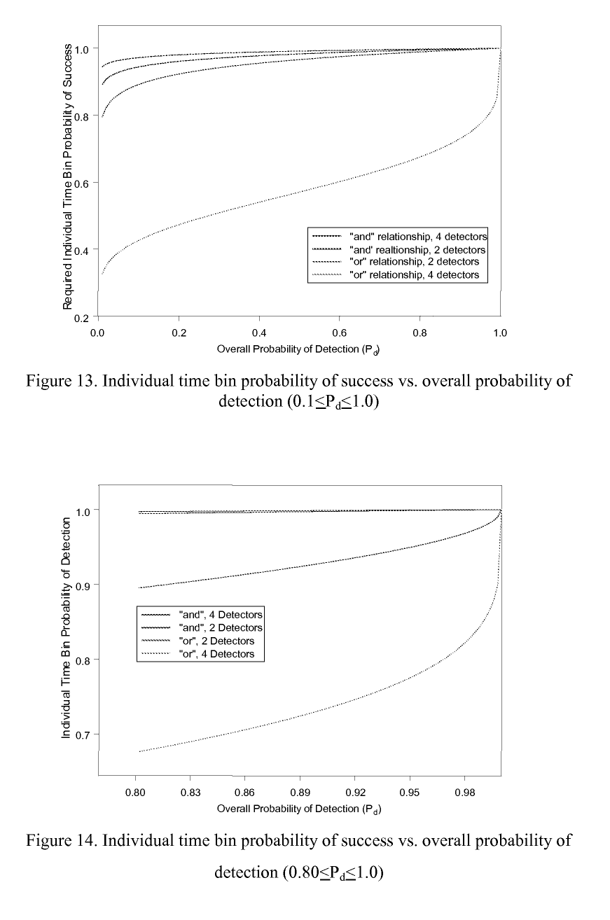

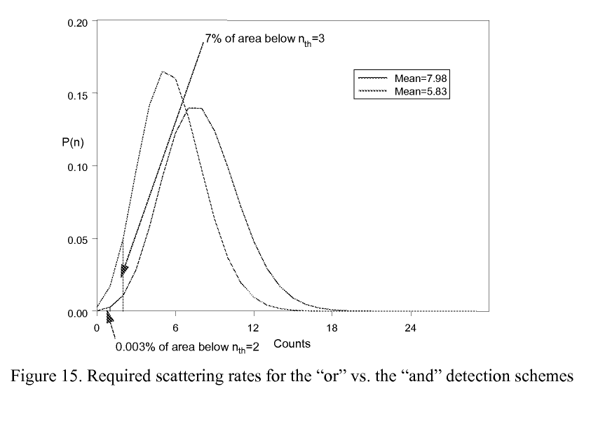

The individual time bin count requirement vs. overall probability of detection is shown in FIG. 13. It can be seen that as the number of detectors increases, the requirements for an individual time bin success increases in the “and” situation and decreases in the “or” situation. This is offset by the lower threshold required in the “and” situation as opposed to the “or” situation (see FIG. 12). It is not immediately obvious which scheme gives the highest probability of detection in a given situation. The “and” scheme requires an extremely high probability of success in an individual time bin, but the requirements for success drop with number of time bins and detectors. The requirements for an individual success decrease with the “or” scheme, but those requirements are higher than for the “and” scheme.

For comparison, consider a case with typical conditions
−P_{d}=0.90
−N_{b}=20
−N_{d}=2

Using the “and” condition gives P(n>nₜₕ_{_{—}}_{and})=0.997, the “or” condition P(n>nₜₕ_{_{—}}ₒᵣ)=0.928.

For 2-4 detectors it appears that the “or” condition gives a greater probability of detection. This is illustrated in FIG. 4. A situation where the threshold number of counts for the “and” threshold is 2 and the “or” threshold is 3 is being considered. This is quite a typical spread in the threshold counts required with normal background conditions. This spread of count threshold depends on background, the number of time bins with above threshold number of counts, and the total time the source is in the field of view. The equation

$$P ( n > {n}_{th} ) = 1 - {\sum }_{k = 0}^{k < {n}_{th}} \frac{{( ( μ ) {τ}_{b} )}^{k}}{k !} {ⅇ}^{- ( ( μ ) {τ}_{b} )}$$

was solved for μ, given that 0.997% of the probability was above at or above the threshold of 2 for and 0.928% of the probability was above the threshold of 3. This results in a mean background+source scatter rate to achieve P_{d}=0.9 of 7.98 for the “and” condition and 5.83 for the “or” condition. Poisson distributions that meet these requirements are shown (mean=7.98 for the “and” distribution and 5.83 for the “or” distribution). In this case it is seen that the source scatter rate required for detection drops with the “or” algorithm vs. the “and” scheme. This means a weaker source can be detected using the “or” scheme than the “and” scheme.

Operations with More than 2 Detectors

With two detectors, the only choices for success in a single time bin are that counts from one detector is above threshold (the “or”) or counts from both detectors are above threshold (the “and”). With more than 2 detectors, success can be defined as 1 to N_{d} detectors with counts above threshold. In this case, the probability of obtaining above threshold counts on nₜₕ out of the N_{d} detectors is

$$P ( success ) = {\sum }_{k = {n}_{h}}^{{N}_{d}} \frac{{N}_{d} !}{( {N}_{d} - k ) ! k !} {{P}_{th}^{k} ( 1 - {P}_{th} )}^{k}$$

As an example, consider the case of requiring at least 2 detectors out of 4 to be above threshold for the counts in a time bin to be an event. The probability of this event occurring in a single time slice is

$${P}_{24} ( success ) = {P}_{th}^{2} ( 6 - 8 {P}_{th} + 3 {P}_{th}^{2} )$$

The threshold probability for h events out of N_{b} time bins is

$${{P}_{th}^{2} ( 6 - 8 {P}_{th} + 3 {P}_{th}^{2} ) [ 1 - {P}_{th}^{2} ( 6 - 8 {P}_{th} + 3 {P}_{th}^{2} ) ]}^{( {N}_{b} - h ) / h} = {( \frac{{P}_{fa} ( {N}_{b} - h ) ! h !}{{C}_{n} {N}_{b} !} )}^{1 / h}$$

Similarly, the requirement on the count distribution, in the h=N_{b} case is

$${P}_{d}^{1 / 2 {N}_{d}} = {P ( n \geq {n}_{th} ) [ 6 - 8 P ( n \geq {n}_{th} ) + 3 {P}^{2} ( n \geq {n}_{th} ) ]}^{1 / 2}$$

For counts from three out of the four detectors required to be above threshold for a source detection the condition on the single detector count distribution is

$${P}_{d}^{1 / 3 {N}_{d}} = {P ( n \geq {n}_{th} ) [ 4 - 3 P ( n \geq {n}_{th} ) ]}^{1 / 3}$$

A comparison of the count probability distribution requirements as a function of the number of detectors above threshold is shown in Table 2

TABLE 2
Required probability above threshold to achieve
P_{d} = 0.9 (h = 20, N_{b} = 20, N_{d} = 4)

| Number of Detectors Above threshold | P(n ≧ nₜₕ) |
|---|---|
| 4 (“and”) | 0.9987 |
| 3 | 0.9698 |
| 2 | 0.8871 |
| 1 (“or”) | 0.7307 |

This follows the pattern seen before with 2 detectors. As the number of detectors whose counts must be above threshold increases, the threshold decreases, but the percentage of the count distribution that must be above the threshold to achieve a desired probability of detection increases.

### REFERENCES

(1) Canberra Industries, 800 Research Parkway, Meridian, Conn. 06450

(2) Scionix Holland BV, Radiation Detectors and Crystals, PO Box 143 3980 CC Bunnik, The Netherlands.

(3) Saint Gobain Crystals and Detectors, 12345 Kinsman Road, Newbury, Ohio, 44065.

(4) P. E. Fehlau, “An Applications Guide to Vehicle SNM Monitors”, Los Alamos National Laboratory Report LA-10912-MS, March 1987.

What is claimed:

1. A method to detect concealed nuclear devices comprising:
Detecting at least two radiation counts comprised of a spectral characteristic,
Determining the detection times associated with the two radiation counts,
Determining the spectral characteristic;
Calculating a correlation between the at least two radiation counts over time;
Transmitting an alarm message if the correlation is at or above a pre-determined threshold.

2. A method to detect concealed nuclear devices comprising:
Detecting at least two radiation counts comprised of a spectral characteristic,
Determining the detection times associated with the two radiation counts,
Determining for each radiation count the identity of the detector that generated the count,
Calculating a correlation between the at least two radiation counts over the identity of the detectors,
Transmitting an alarm message if the correlation is at or above a pre-determined threshold.

3. A method to detect concealed nuclear devices comprising:
Detecting at least two radiation counts comprised of a spectral characteristic,
Determining the detection times associated with the two radiation counts,
Determining the spectral characteristic;
Calculating a first probability that at least one of the at least two radiation counts came from a source by determining the probability that all of the counts are not correlated with a source;
Comparing the first probability to the probability that background radiation caused all of the radiation counts,
Creating an alarm output if the correlation is at or above a pre-determined threshold.

4. A method to detect concealed nuclear devices comprising:
Detecting at least two radiation counts comprised of a spectral characteristic,
Determining the detection times associated with the two radiation counts,
Determining the spectral characteristic;
Calculating a first probability that at least one of the at least two radiation counts came from a source by determining the probability that N of the counts are not correlated with a source, N being a number including 1 and between 1 and the number of detectors in the device;
Comparing the first probability to the probability that background radiation caused all of the radiation counts,
Creating an alarm output if the correlation is at or above a pre-determined threshold.

5. A method to detect concealed nuclear devices comprising:
Detecting at least two radiation counts comprised of a spectral characteristic,
Determining the detection times associated with the two radiation counts,
Determining the spectral characteristic;
Calculating a first probability that at least one of the at least two radiation counts came from a source by determining the probability that N of the counts are not correlated with a source, N being a number including 1 and between 1 and a predetermined number of time slices during which the detection takes place;
Comparing the first probability to the probability that background radiation caused all of the radiation counts,
Creating an alarm output if the correlation is at or above a pre-determined threshold.

6. A method to detect concealed nuclear devices comprising:
Detecting at least two radiation counts comprised of a spectral characteristic,
Determining the detection times associated with the two radiation counts,
Determining the spectral characteristic;
Calculating a first probability using either the “and” scheme step or the “or” scheme step;
Comparing the first probability to the probability that background radiation caused all of the radiation counts,
Creating an alarm output if the correlation is at or above a pre-determined threshold.
